(19) United States
(12) Patent Application Publication
(10) Pub. No.: US 2010/0324197 A1
(43) Pub. Date: Dec. 23, 2010

(54) ORGANO-NEUTRALIZED CALCINED KAOLINS FOR USE IN SILICONE RUBBER-BASED FORMULATIONS

(75) Inventors: Robert W. Bradshaw, Milledgeville, GA (US); Walter J. Polestak, Summit, NJ (US); Edward J. Sare, Macon, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Imerys Kaolin, Inc.

(21) Appl. No.: 12/869,858

(22) Filed: Aug. 27, 2010

Related U.S. Application Data
(62) Division of application No. 11/576,073, filed on Feb. 12, 2008.
(60) Provisional application No. 60/616,115, filed on Oct. 6, 2004.

(51) Int. Cl. C08K 3/34

(52) U.S. Cl. 524/447

(57) ABSTRACT

Disclosed herein are organo-neutralized calcined kaolins comprising calcined kaolin treated with at least one basic organic compound, a composition comprising the organo-neutralized calcined, and use of the organo-neutralized calcined kaolin in silicone rubber formulations. Further disclosed herein are a method of making the organo-neutralized calcined kaolin and a method of making a silicone rubber formulation comprising the organo-neutralized calcined kaolin.

This application claims priority to U.S. Provisional Patent Application No. 60/616,115, filed Oct. 6, 2004.

Disclosed herein is an improved, surface treated, calcined kaolin (“organo-neutralized calcined kaolin”) and the use thereof. Further disclosed herein are a composition comprising the organo-neutralized calcined kaolin and the use of the organo-neutralized calcined kaolin in silicone rubber formulations. Even further disclosed herein are a method of manufacturing the organo-neutralized calcined kaolin and a method of making a silicone rubber formulation comprising the organo-neutralized calcined kaolin.

In silicone rubber formulation, it is known to use silica fillers, such as crystalline silica, precipitated silica and fumed silica. However, use of the silica fillers can be costly and may raise concerns from a material hazard standpoint. Therefore, there is a need to find replacement or extension of the silica fillers without compromising the properties of the final silicone rubber product.

Calcined kaolin can be used as extending fillers in polymerization, such as in silicone rubber formulation. However, depending on, for example, the type of silicone polymer and/or the addition of specialty modifiers, calcined kaolin may not be used as the replacement and/or extending fillers, as they may retard or inhibit the curing process. In other words, calcined kaolin's usefulness and applicability may be limited due to their detrimental effects on the curing of, for example, the silicone rubber formulations.

Therefore, there remains a need for replacement and/or extension of the silica fillers using modified calcined kaolin, which can exhibit substantive levels of reinforcement, but do not inhibit the curing of silicone rubber formulations.

The present inventors have surprisingly found that treatment of the calcined kaolin with at least one basic organic compound can provide organo-neutralized calcined kaolin, which can satisfy at least one of the above-mentioned needs. The organo-neutralized calcined kaolin as disclosed herein can be used, for example, as a filler, a semi-reinforcing agent, and/or an extender for reinforcing agents, in polymerizing and cross-linking reactions using free-radical initiators. In one embodiment, the organo-neutralized calcined kaolin is used in silicone rubber formulations, such as in formulating heat-resisting silicone rubbers.

It has been found that the calcined kaolins that have poor curing responses also have highly acidic sites or centers on the surface, using the method of Benesi, as published in J. Am. Chem. Soc., vol. 78, pages 5490-5494. It is believed that a detrimental reaction can occur between the free-radical initiator in a polymer system and mineral fillers when acidic species, such as Lewis acids, ionically cleave the initiator, making the initiator inert. The resulting inert initiator fragments do not contain free radicals and therefore cannot start or propagate a radical chain reaction. For example, in a compounded silicone rubber system, the degree and efficiency of cross-linking reaction can be greatly affected by acid cleavage, which may lead to no cure or a poor cure with poor rubber-like properties.

The present inventors have surprisingly found that, by treating calcined kaolin with at least one basic organic compound, the surface acidities (Lewis acids) of the calcined kaolin can be reduced. Consequently, the performance of the organo-neutralized calcined kaolin can be improved in the curing process. The organo-neutralized calcined kaolin as disclosed herein can, for example, replace, as an extender, up to 50% of the precipitated silica used in silicone rubber formulations as a reinforcing agent.

Accordingly, one aspect of the present disclosure relates to an organo-neutralized calcined kaolin, comprising calcined kaolin treated with at least one basic organic compound.

Another aspect of the present disclosure provides a composition comprising an organo-neutralized calcined kaolin, wherein the organo-neutralized calcined kaolin comprises calcined kaolin treated with at least one basic organic compound.

As used herein, the term “organo-neutralized” means treatment with at least one basic organic compound so that the surface acidities (Lewis acids) of the calcined kaolin can be deactivated, i.e., reduction of the acid potential of the acid sites on the kaolin surface. The term “neutralized” does not necessarily mean that the pH value of the kaolin surface is at or near 7. The deactivation of the surface acidities of the calcined kaolin can be achieved by various mechanisms, such as a classical acid/base mechanism, binding of a molecule that stearically blocks the acid site, and other chemical modifications of the acid site.

As disclosed herein, the at least one basic organic compound may be chosen, for example, from basic organic compounds well known in the art with a pKa of greater than 7.0, such as amines chosen, for example, from primary, secondary and tertiary (poly)amines; amino ethers; and alkanolamines, wherein the alkyl group can comprise, for example, from 1 to 20 carbon atoms. The amines can be chosen, for example, from methylamine, ethylamine, diethylamine, and 1,3-propanediamine. An example of the amino ethers is morpholine. The alkanolamines can be chosen, for example, from 2-amino-2-methyl-1-propanol (2-AMP), monoethanolamine, diethanolamine, triethanolamine (TEA), monoisopropanolamine, diisopropanolamine, triisopropanolamine, diethylaminoethanol (DEAE), methylethanolamine, dimethylethanolamine, ethylaminoethanol, and amino-methypropanol. The at least one basic organic compound can also be chosen, for example, from amino acids with a pKa of greater than 7.0, such as glycine, and basic organic compounds derived from a substituted vinyl compound comprising at least one basic atom, such as dialkylaminoalkyl methacrylate and dialkylaminoalkyl acrylate, dialkylaminoalkylmethacrylamide and -acrylamide. The at least one basic organic compound can also be chosen from esters comprising substituents chosen from primary, secondary, and tertiary amine substituents of acrylic and methacrylic acids. For example, the at least one basic organic compound can be chosen from N-substituted acrylamides or methacrylamides, wherein the alkyl group comprises from 2 to 12 carbon atoms, such as N-ethylacrylamide, N-tert-butylacrylamide, N-tert-octylacrylamide, N-octylacrylamide, N-decylacrylamide, N-dodecylacrylamide and the corresponding methacrylamides. In one embodiment, the at least one basic organic compound is chosen from aminoethyl, butylaminoethyl, N,N′-dimethylaminoethyl and N-tert-butylaminoethyl methacrylates.

As disclosed herein, the neutralizing treatment of calcined kaolin is performed in an ionizing medium, such as water. In one embodiment, the calcined kaolin is slurried using an aqueous medium, such as water, and is treated and well mixed with the at least one basic organic compound (wet soaked approach). In another embodiment, a dilute aqueous solution of the at least one basic organic compound is prepared and is misted or sprayed onto the calcined kaolin (misting or spraying approach). As disclosed herein, the misting approach also includes, for example, treatment performed in a fluidized bed. However, as shown in Example 2, after, for example, drying, such as pan drying, spay drying, and drying in a fluidized bed dryer, and when compounded into a silicone rubber formulation, the organo-neutralized calcined kaolin treated using the wet-soaked approach can provide better physical properties to the resulting silicone rubber product than that treated using the misting or spraying approach. In another embodiment, the at least one basic organic compound and the calcined kaolin are added separately to a compounding masterbatch.

The degree of neutralization of the organo-neutralized calcined kaolin as disclosed herein can be determined using an absorbed Hammett indicator, such as a dicinnamalacetone/benzene (DCB) acidity indicator, which is widely used for determining the surface acidity of solids, such as catalysts. See Benesi, J. Am. Chem. Soc., vol. 78, pages 5490-5494.

The calcined kaolin as disclosed herein can have a median particle size ranging, for example, from about 0.5 μm to about 5.0 μm, such as from about 3.0 μm to 4.0 μm, and further such as about 3.5 μm. The median particle size of the calcined can be determined by, for example, a standard test procedure employing Stokes' Law of Sedimentation. For example, the median particle size of the calcined kaolin can be determined by measuring the sedimentation of the particulate product in a fully dispersed condition in a standard aqueous medium, such as water, using a SEDIGRAPH™ instrument, e.g., SEDIGRAPH 5100, obtained from Micromeritics Corporation, USA.

The organo-neutralized calcined kaolin as disclosed herein, such as alkanolamine treated calcined kaolin, can also have better dispersion performance, e.g., higher Hegman grind value, than those without the organo-neutralization, given the same degree of pulverization. For example, the organo-neutralized calcined kaolin, such as alkanolamine treated calcined kaolin, can have a high Hegman grind value of, for example, greater than about 3 after drying and pulverizing with two passes in a pulverizer, such as greater than about 4, further such as great than about 5, and even further such as great than about 6. In one embodiment, the organo-neutralized calcined kaolin as disclosed here has a Hegman grind value of greater than about 7.

The organo-neutralized calcined kaolin as disclosed herein can also be compounded into a polymer system, such as silicone rubber formulations, at much higher loadings without adversely affecting the curing process than those which are not organo-neutralized. In addition, the organo-neutralized calcined kaolin as disclosed herein, when compounded in a silicone rubber formulation, can provide similar mechanical properties to the resulting silicone rubber product as silica fillers widely used in the industry, and may even at a lower loading. For example, the mechanical properties of a silicone rubber compounded with 50 parts of the organo-neutralized calcined kaolin as disclosed herein can be comparable to the properties of silicone rubber compounded with 100 parts of US Silica's Min-U-Sil 5 (ca 1.0 μm average particle size), which is considered to be the premium natural silica extender and semi-reinforcing agent used in the silicone rubber industry.

Further disclosed herein are products comprising the organo-neutralized calcined kaolin as disclosed herein. These products are chosen, for example, from polymer products and silicone rubber products.

In one embodiment, the present disclosure provides a polymer product comprising an organo-neutralized calcined kaolin as disclosed herein, which can function as a filler, an extender, and/or a reinforcing agent. Depending on the particular polymer system and desired physical properties of the final polymer product, the organo-neutralized calcined kaolin can be present in a concentration ranging, for example, from about 1 to about 200 phr, such as from about 1 to about 100 phr, by weight of the final polymer product.

The polymer product disclosed herein comprises at least one polymer resin. The term “resin” means a polymeric material, either solid or liquid, prior to shaping into a plastic article. The at least one polymer resin used herein is one which, on curing, can form a plastic material. For example, the polymer product disclosed herein is chosen from cured polymers, such as free radical cured polymers and peroxide cured polymers. The polymers, which can be cured using peroxides as the crosslinker, include, for example, unsaturated polyesters, polyurethanes, polyethylenes, silicones, and elastomers. In one embodiment, the peroxides for unsaturated polyesters can be chosen, for example, from organic peroxides, such as diacyl peroxides (for example, decanoyl peroxide, lauroyl peroxide, and benzoyl peroxide); ketone peroxides (for example, 2,4-pentanedione peroxide); peroxyesters (for example, t-butyl peroxyneodecanoate, 2,5-dimethyl 2,5-di(2-ethylhexanoyl peroxy)hexane, t-amyl peroxy-2-ethyl-hexanoate, t-butyl peroxy-2-ethyl-hexanoate, t-amyl peroxyacetate, t-butyl peroxyacetate, and t-amyl perbenzoate); dialkyl peroxides (for example, dicumyl peroxide, 2,5-dimethyl-2,5-di-(t-butyl peroxy)hexane, bis(t-butyl peroxy)diisopropyl-benzene, di-t-amyl peroxide, di-t-butyl peroxide and 2,5-dimethyl-2,5-di-(t-butyl peroxy)hexyne-3); hydroperoxides (for example, cumene hydroperoxide); and peroxyketals (for example, 1,1-di-(t-butyl peroxy)-3,3,5-trimethyl-cyclohexane and 1,1-di-(t-butyl peroxy)-cyclohexane).

The at least one polymer resin, which can be used herein, can be chosen, for example, from polyolefin resins, polyamide resins, polyester resins, engineering polymers, allyl resins, and thermoset resins.

In another embodiment, the present disclosure provides a silicone rubber product comprising an organo-neutralized calcined kaolin as disclosed herein. The organo-neutralized calcined kaolin as disclosed herein can provide the benefits of resin extension, reinforcement of the rubber, and increased hardness of the rubber composition. In the silicone rubber product as disclosed herein, the organo-neutralized calcined kaolin is present in an amount ranging, for example, from about 1 to about 200 phr, such as from about 1 to about 100 phr, by weight of the rubber.

Further disclosed herein is a silicone rubber formulation, comprising

at least one filler comprising an organo-neutralized calcined kaolin, wherein the organo-neutralized calcined kaolin comprises calcined kaolin treated with at least one organic compound in an amount sufficient to reduce the activity of surface acid sites of the calcined kaolin; and

at least one silicone polymer.

Further disclosed herein is a method of manufacturing an organo-neutralized calcined kaolin, comprising treating a calcined kaolin with at least one basic organic compound. Such treatment can be in an ionizing medium. The ionizing medium can be chosen, for example, from aqueous media, such as water. Examples of the treatment include water spraying, misting, mixing, coating in a fluidized bed or paddle mixer, and treatment in a steam mill. The at least one basic organic compound is present in an amount of equal to or greater than 0.1%, by weight, ranging, for example, from about 0.1% to about 1.0%, such as from about 0.1% to about 0.5%, and further such as about 0.2% by weight of the calcined kaolin in the treatment.

In one embodiment, the treating operation comprises slurrying a calcined kaolin in water and mixing the resulting calcined kaolin with at least one basic organic compound. In addition, the method disclosed herein can further comprise drying, such as pan drying, spray drying, and drying in a fluidized bed dryer, and pulverizing the calcined kaolin treated with at least one basic organic compound.

Even further disclosed herein is a method of making a silicone rubber product, comprising adding into a silicone rubber formulation an organo-neutralized calcined kaolin, wherein the silicone rubber formulation comprises at least one silicone elastomer and at least one initiator and the organo-neutralized calcined kaolin comprises calcined kaolin treated with at least one basic organic compound. In addition, the silicone rubber formulation can further comprise at least one other filler, chosen, for example, from precipitated silica, crystalline silica, and fumed silica.

Further disclosed herein is a method for making a silicone rubber product, comprising adding into a silicone rubber formulation a calcined kaolin and at least one basic organic compound, wherein the silicone rubber formulation comprises at least one silicone elastomer and at least one initiator. In one embodiment, the calcined kaolin and the at least one basic organic compound are added substantially simultaneously. In another embodiment, the calcined kaolin is added before the at least one basic organic compound. In yet another embodiment, the calcined kaolin may be added after the at least one basic organic compound. In addition, the silicone rubber formulation can further comprise at least one additional filler, chosen, for example, from precipitated silica, crystalline silica, and fumed silica.

All amounts, percentages, and ranges expressed herein are approximate.

The present invention is further illuminated by the following non-limiting examples, which are intended to be purely exemplary of the invention.

### EXAMPLES

### Example 1

### Replacement/Extension of Precipitated Silica in Silicone Rubber

A commercial calcined kaolin A with a median particle size of about 1.5 μm treated with 2-AMP was used in comparison with a commercial fumed silica with a median particle size of about 1.0 μm in replacing or extending a portion of an 18 nm precipitated silica in a silicone rubber formulation. The silicone rubber formulation comprised 100 phr of SWS-725, 0.6 phr of Luperox 500 R (initiator), and various amount of fillers as shown below. 20 parts of the 18 nm precipitated silica was used as a control. Mixtures of 15 parts of the 18 nm precipitated silica and of 5 parts of 2-AMP treated commercial calcined kaolin A or a commercial fumed silica were used. In addition, mixtures of 10 parts of the 18 nm precipitated silica and of 10, 30, 50, or 70 parts of 2-AMP treated commercial calcined kaolin A or the commercial fumed silica were used. Compounding was performed in the laboratory using a standard 2-roll mill With no heat. The treatment level was 0.2% by weight of the calcined kaolin. The polymer was compression molded/cured at 340° F. and 1000 psi for 10 minutes. The physical properties of the resulting silicone rubbers were determined, including the Shore “A” Hardness, tensile at break, elongation at break and modulus at 100%, 200%, and 300%. The Shore “A” Hardness was measured according to ASTM D 2240 using a Type A durometer. The tensile at break and elongation at break were measured according to ASTM D 412 Method A. The modulus at 100%, 200%, and 300% were measured using an Instron 1120 device. The results are shown in Tables 1 and 2.

TABLE 1

| | The 18 nm Precipitated Silica/2-AMP Treated Commercial | | | | | |
|---|---|---|---|---|---|---|
| | Calcined Caolin A (T) Or Commercial Fumed Silica (M) | | | | | |
| Amount (phr) | 10/30T | 10/30M | 10/50T | 10/50M | 10/70T | 10/70M |
| Shore “A” Hardness | 65 | 60 | 69 | 63 | 73 | 67 |
| Tensile at Break (psi) | 900 | 875 | 785 | 790 | 735 | 745 |
| Elongation at Break (%) | 400 | 405 | 320 | 360 | 225 | 290 |
| Modulus | | | | | | |
| at 100% (psi) | 360 | 265 | 445 | 305 | 530 | 370 |
| at 200% (psi) | 595 | 505 | 665 | 565 | 720 | 645 |
| at 300% (psi) | 745 | 695 | 765 | 715 | — | — |

TABLE 2

| | The 18 nm Precip- | The 18 nm Precipitated Silica/2-AMP Treated Commercial | | | |
|---|---|---|---|---|---|
| | itated Silica | Calcined Caolin A (T) Or Commercial Fumed Silica (M) | | | |
| Amount (phr) | 20 | 15/5T | 15/5M | 10/10T | 10/10M |
| Shore “A” Hardness | 68 | 63 | 63 | 60 | 57 |
| Tensile at Break (psi) | 1100 | 1105 | 1085 | 1020 | 1040 |
| Elongation at Break (%) | 440 | 465 | 460 | 465 | 475 |
| Modulus | | | | | |
| at 100% (psi) | 235 | 235 | 225 | 240 | 215 |
| at 200% (psi) | 425 | 445 | 425 | 450 | 415 |
| at 300% (psi) | 690 | 675 | 665 | 650 | 630 |

As shown in Table 1, with an increase of the loading level of the filler, such as an example of the inventive filler (i.e., 2-AMP treated commercial calcined kaolin A), the shore “A” hardness and modulus of the final silicone rubbers increase.

As shown in Table 2, the physical properties of the silicone rubbers compounded with the mixture of the 18 nm precipitated silica and 2-AMP treated commercial calcined kaolin A are comparable to, or even superior to those compounded with the mixture of the 18 nm precipitated silica and the commercial fumed silica. In addition, the physical properties of the silicone rubbers compounded with 15 parts of the 18 nm precipitated silica and 5 parts of 2-AMP treated commercial calcined kaolin A are comparable to those compounded with 20 parts of the 18 nm precipitated silica. Further, the physical properties of the silicone rubbers compounded with 10 parts of the 18 nm precipitated silica and 10 parts of 2-AMP treated commercial calcined kaolin A are comparable to those compounded with 20 parts of the 18 nm precipitated silica. Therefore, the result indicates that the organo-neutralized calcined kaolin as disclosed herein can be used to replace or extend the use of silica fillers in silicone rubber formulation.

### Example 2

A wet-soaked approach and a misting or spraying approach for treating calcined kaolin were compared. Commercial calcined kaolin A was used to be mist-treated with a dilute solution of 2-AMP at a treatment level of 0.2% by weight of the calcined kaolin. After tumble-mixing in a Waring Blender, the damp powder (approximately 10% moisture) was dried and then pulverized twice. Another set of commercial calcined kaolin A sample was slurried in water and 2-AMP was added at a treatment level of 0.2% by weight of the calcined kaolin. The mixing was done for about 15 minutes to 30 minutes, the mixture was dried and then pulverized twice. The resulting organo-neutralized calcined kaolins via both approaches were then compounded at 50 phr in a standard silicone rubber system comprising 100 phr of SWS-725 and 0.6 phr of Luperox (initiator). Compounding was performed in the laboratory using a standard 2-roll mill with no heat. The polymer was compression molded/cured at 340° F. and 1000 psi for 10 minutes. The physical properties of the resulting silicone rubbers were determined, including the Shore “A” Hardness, tensile at break, elongation at break and modulus at 100%, 200%, and 300%, as described. The result is shown in Table 3.

TABLE 3

| | Wet-Soaked | Misted |
|---|---|---|
| Properties | Approach | Approach |
| Shore “A” Hardness | 60 | 59 |
| Tensile at Break (psi) | 675 | 635 |
| Elongation at Break (%) | 380 | 385 |
| Modulus | | |
| at 100% (psi) | 350 | 330 |
| at 200% (psi) | 540 | 505 |
| at 300% (psi) | 620 | 580 |

As shown in Table 3, the silicone rubbers compounded with organo-neutralized calcined kaolin produced by the wet-soaked approach possess superior physical properties to those compounded with organo-neutralized calcined kaolin produced by the misting or spraying approach.

### Example 3

Commercial calcined kaolin A treated with 0.2% of 2-AMP and commercial calcined kaolin A treated with 0.1% of morpholine were compared. Commercial calcined kaolin A was slurried in water and 2-AMP was added at a treatment level of 0.2% by weight of the calcined kaolin. Another set of commercial calcined kaolin A sample was slurried in water and morpholine was added at a treatment level of 0.1% by weight of the calcined kaolin. The mixing was done for about 15 minutes to 30 minutes, the mixtures were dried and then pulverized twice. The resulting organo-neutralized calcined kaolins via both approaches were then compounded at 50 phr in a standard silicone rubber system comprising 100 phr of SWS-725 and 0.6 phr of Luperox (initiator). Compounding was performed in the laboratory using a standard 2-roll mill with no heat. The polymers were compression molded/cured at 340° F. and 1000 psi for 10 minutes. The physical properties of the resulting silicone rubbers were determined, including the Shore “A” Hardness, tensile at break, elongation at break and modulus at 100%, 200%, and 300%, as described. The result is shown in Table 4.

TABLE 4

| | 0.2% 2-AMP | 0.1% Morpholine |
|---|---|---|
| Properties | Treated | Treated |
| Shore “A” Hardness | 60 | 59 |
| Tensile at Break (psi) | 675 | 695 |
| Elongation at Break (%) | 380 | 355 |
| Modulus | | |
| at 100% (psi) | 350 | 315 |
| at 200% (psi) | 540 | 565 |
| at 300% (psi) | 620 | 660 |

As shown in Table 4, the silicone rubbers compounded with organo-neutralized calcined kaolin produced by the treatment of 2-AMP or morpholine possess similar physical properties.

### Example 4

2-AMP treated commercial calcined kaolin A was compared with triethanolamine, diisopropanolamine, or triisopropanolamine treated commercial calcined kaolin A. Commercial calcined kaolin A was slurried in water and treatment agents were added separately at a treatment level of 0.2% by weight of the calcined kaolin. The mixing was done for about 15 minutes to 30 minutes, the mixtures were dried and then pulverized twice in a micropulverizer. The resulting samples had pH values ranging from 7.2 to 7.7. The resulting organo-neutralized calcined kaolins were then compounded at 50 phr separately in a standard silicone rubber system comprising 100 phr of SWS-725 and 0.6 phr of Luperox (initiator). Compounding was performed in the laboratory using a standard 2-roll mill with no heat. The polymers were compression molded/cured at 340° F. and 1000 psi for 10 minutes. The physical properties of the resulting silicone rubbers were determined, including the Shore “A” Hardness, tensile at break, elongation at break and modulus at 100%, 200%, and 300%, as described. The result is shown in Table 5.

TABLE 5
Commercial Calcined Kaolin A + 0.2% of Alkanolamines

| | Triethanol- | Diisopro- | Triisopro- | 2- |
|---|---|---|---|---|
| | amine | panolamine | panolamine | AMP |
| Shore “A” Hardness | 59 | 60 | 59 | 60 |
| Tensile at Break (psi) | 675 | 670 | 665 | 655 |
| Elongation at Break | 375 | 355 | 385 | 360 |
| (%) | | | | |
| Modulus | | | | |
| at 100% (psi) | 335 | 350 | 330 | 340 |
| at 200% (psi) | 535 | 550 | 525 | 535 |
| at 300% (psi) | 625 | 630 | 610 | 620 |

As shown in Table 5, the physical properties of the silicone rubbers compounded with triethanolamine, diisopropanolamine, or triisopropanolamine treated commercial calcined kaolin A are comparable to those compounded with 2-AMP treated commercial calcined kaolin A.

Unless otherwise indicated, all numbers expressing quantities used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-48. (canceled)

49. A silicone rubber formulation, comprising at least one filler comprising an organo-neutralized calcined kaolin, wherein the organo-neutralized calcined kaolin comprises calcined kaolin treated with at least one organic compound in an amount sufficient to reduce the activity of surface acid sites of the calcined kaolin;
and at least one silicone polymer.

50. The silicone rubber formulation according to claim 49, wherein the at least one basic organic compound is chosen from amines, amino ethers, and alkanolamines.

51. The silicone rubber formulation according to claim 50, wherein the amines are chosen from primary, secondary and tertiary (poly)amines.

52. The silicone rubber formulation according to claim 51, wherein the amines are chosen from methylamine, ethylamine, diethylamine, and 1,3-propanediamine.

53. The silicone rubber formulation according to claim 50, wherein the amino ether is morpholine.

54. The silicone rubber formulation according to claim 50, wherein the alkanolamines are chosen from those whose alkyl group comprises from 1 to 20 carbon atoms.

55. The silicone rubber formulation according to claim 54, wherein the alkanolamines are chosen from 2-amino-2-methyl-1-propanol, monoethanolamine, diethanolamine, triethanolamine, diisopropanolamine, triisopropanolamine, diethylaminoethanol, methylethanolamine, dimethylethanolamine, ethylaminoethanol, and amino-methypropanol.

56. The silicone rubber formulation according to claim 49, wherein the at least one basic organic compound is chosen from amino acids with a pKa of greater than 7.0.

57. The silicone rubber formulation according to claim 56, wherein the at least one basic organic compound is glycine.

58. The silicone rubber formulation according to claim 49, wherein the at least one basic organic compound is in an amount of equal to or greater than 0.1% by weight of the calcined kaolin in the treatment.

59. The silicone rubber formulation according to claim 58, wherein the at least one basic organic compound is in an amount ranging from 0.1% to 1.0% by weight of the calcined kaolin in the treatment.

60. The silicone rubber formulation according to claim 59, wherein the at least one basic organic compound is in an amount ranging from 0.1% to 0.5% by weight of the calcined kaolin in the treatment.

61. The silicone rubber formulation according to claim 60, wherein the at least one basic organic compound is in an amount of 0.2% by weight of the calcined kaolin in the treatment.

62. The silicone rubber formulation according to claim 49, wherein the organo-neutralized calcined kaolin is present in a concentration ranging from 1 to 200 phr in the silicone rubber formulation.

63. The silicone rubber formulation according to claim 62, wherein the organo-neutralized calcined kaolin is present in a concentration ranging from 1 to 100 phr in the silicone rubber formulation.

64-80. (canceled)

81. A method of making a silicone rubber product, comprising adding into a silicone rubber formulation an organo-neutralized calcined kaolin, wherein the silicone rubber formulation comprises at least one silicone polymer and at least one initiator and the organo-neutralized calcined kaolin comprises calcined kaolin treated with at least one basic organic compound in an amount sufficient to reduce the activity of surface acid sites of the calcined kaolin.

82. The method according to claim 81, wherein the silicone rubber formulation further comprises at least one silica filler.

83. The method according to claim 82, wherein the at least one silica filler is chosen from precipitated silica, crystalline silica, and fumed silica.

84. A method of making a silicone rubber product, comprising adding into a silicone rubber formulation a calcined kaolin and at least one basic organic compound in an amount sufficient to reduce the activity of surface active sites of the calcined kaolin, wherein the silicone rubber formulation comprises at least one silicone polymer and at least one initiator.

85. The method according to claim 84, wherein the silicone rubber formulation further comprises at least one silica filler.

86. The method according to claim 85, wherein the at least one silica filler is chosen from precipitated silica, crystalline silica, and fumed silica.
